(19) United States
(12) Patent Application Publication
(10) Pub. No.: US 2010/0262368 A1
(43) Pub. Date: Oct. 14, 2010

(54) Brake Controller Utilizing a Global Positioning System

(75) Inventor: Gary Kaminski, Emporia, KS (US)

Correspondence Address: SHERIDAN ROSS PC, 1560 BROADWAY, SUITE 1200, DENVER, CO, 80202, US

(73) Assignee: Hopkins Manufacturing Corporation, Emporia, KS (US)

(21) Appl. No.: 12/420,327

(22) Filed: Apr. 8, 2009

(51) Int. Cl. G01C 21/00; G01S 19/52

(52) U.S. Cl. 701/213; 342/357.35

(57) ABSTRACT

A GPS data based towed vehicle braking control system and related methods are provided. In operation, an auxiliary braking system for positioning within a towed vehicle and for actuation of the brakes thereof, is provided. The system is designed to activate the auxiliary braking system only when brakes of a towing vehicle are themselves actuated. The system includes a sensing mechanism with integrated logic mechanism. The system also has a power mechanism associated with the sensing mechanism. Further, a brake actuation mechanism is associated with the sensing mechanism. In operation, the sensing mechanism employs a global positioning system (GPS) sensing device that senses the location of the auxiliary braking system. Integrated logic mechanism can then provide information to the brake actuation mechanism to selectively cause the auxiliary braking system to apply force to brakes associated with a towed vehicle.

### CROSS REFERENCE TO RELATED APPLICATIONS

This application is related to pending U.S. patent application Ser. No. 11/561,196, filed Nov. 17, 2006, which claims the benefit of expired U.S. Provisional Patent Application Ser. No. 60/739,376, filed Nov. 23, 2005, the entire disclosures of which are incorporated by reference herein. This application is also related to U.S. Pat. No. 6,634,466, abandoned U.S. patent application Ser. No. 10/295,967, U.S. Pat. No. 6,918,466, U.S. Pat. No. D498,190, U.S. Pat. No. D477,553, abandoned U.S. patent application Ser. No. 10/739,491, and U.S. Pat. D551,139, the entire disclosures of which are incorporated by reference herein.

### BACKGROUND OF THE INVENTION

Individuals traveling by recreational vehicle (“towing vehicle”), for example, often desire to tow a secondary vehicle (“towed vehicle”). Often the towed vehicle, such as a car, possesses a braking system. Due to the weight or other characteristics of some towed vehicles, it is desirable to coordinate braking of the towed vehicle with braking of the towing vehicle to prevent the towed vehicle from damaging the towing vehicle or visa-versa. For example, picture a towing vehicle traveling down a steep incline towing a heavy towed vehicle. Application of the towing vehicle's brakes in that situation, without application of the towed vehicle's brakes, will allow the towed vehicle to continue to move relative to the towing vehicle. Such unconstrained movement of the towed vehicle is counteracted by a hitch that interconnects the towed vehicle to the towing vehicle. Thus one can quickly appreciate that failure of the hitch could result in damage to the towed and/or towing vehicle. When the brakes of the towed and towing vehicle are coordinated, however, forces on the hitch are dramatically reduced and safety is increased.

There are systems that control braking of the towed vehicle (i.e., a trailer or dinghy) when the brakes of the towing vehicle are applied. The basic components of such systems generally include a device that senses braking of the towing vehicle, a logic device, a power output device, and a towing vehicle brake actuation device. In most instances, the logic device is either an analog circuit or a microprocessor. The power output device is usually a metal-oxide-semiconductor field-effect transistor (MOFET) of some type, though other devices are also employed. There is, however, significant variation in the devices and methods used to sense braking of the towing vehicle.

One method of sensing braking of the towing vehicle (often referred to herein as a “braking situation”) is to monitor electrical circuits associated with the towing vehicle's braking systems to determine if the towing vehicle brakes have been applied. Most commonly, a brake light circuit of the towing vehicle that generates a “brakes are on” signal is monitored to initiate application of the towed vehicle brakes. One disadvantage of this method of signaling application of the towing vehicle brakes is that the brake light signal is either “on” or “off”, therefore, not providing any indication of the magnitude of the braking force applied by the towing vehicle. Systems also exist that interconnect directly to system sensors of a towing vehicle to achieve an expanded range of breaking information. Typical sensing inputs monitored in these systems are brake master cylinder pressure, ABS status, vehicle speed, brake light circuit status, steering wheel position, etc.

Another common prior art system senses the towing vehicle's brake pedal position to determine applied braking force and often are used in conjunction with brake light systems described above. These systems employ mechanical mechanisms for sensing brake pedal position and are often difficult to install and not terribly accurate.

The most common method of determining the braking situation of the towing vehicle, however, employs sensing the inertia of the towed and/or the towing vehicle. Historically, such systems used pendulums to detect changes in inertia. In more recent years, however, solid-state accelerators, both single and dual axis accelerators, have been employed. All inertia-based systems generally suffer from one primary drawback—gravitational forces interfere with the system's ability to detect decelerations due to braking. One method to address this limitation is to sense the towing vehicle's brake light circuit in addition to inertia readings. In this type of system, the brake controller will not apply the towed vehicle brakes in response to a change in inertia unless the towing vehicle brakes, as determined by a positive brake light signaling indication, are also applied. Thus towed vehicle braking promoted by inertia readings associated with the perceived decelerations attributed with going up a hill, for example, are considered. Another method of addressing gravitational interference is to employ a dual axis accelerometer that may be mounted with each axis at 45 degrees relative to the horizontal plane. The dual axis accelerometer produces readings that closely reflect only the inertial affect of braking. In practice, however, it is difficult to assess the horizontal reference plane, and it is thus difficult to correctly align a brake controller employing a dual axis accelerometer.

An inherent drawback with all the systems described above is that they do not measure the true condition of the towing vehicle. For example, the hydraulic pressure of the towing vehicle's braking system indicates how severely the towing vehicle's brakes are applied, but provides no indication of the adhesion between the towing vehicle and the road. In another example, accelerometers can be used to sense all the changes in the inertia of the towing vehicle via multiple information input, but may not properly determine the cause of the inertia change. In view of the foregoing, one of skill in the art will appreciate that sensing the absolute position of the towing vehicle and tracking the changes in that absolute position can improve control over the towed vehicle braking systems.

### SUMMARY OF THE INVENTION

It is one aspect of the present invention to employ a Global Positioning System (GPS) to determine the horizontal and/or vertical position of the towing or towed vehicle. By monitoring the position of a vehicle in all three GPS axes at several points in time, the brakes of the towed vehicle can be controlled in a manner that more succinctly mimics the towing vehicle's motion and real time braking action.

The proposed brake controller of one embodiment employs conventional GPS technology to determine and store a three dimensional location of a vehicle (either towing or towed) at a given point in time. Subsequently, successive readings of vehicle location are obtained. The frequency in which data is obtained could be pre-set, based on a mathematical calculation done in response to recent changes in vehicle GPS positions, and/or based on maps that help predict changes in terrain or obstacles that would necessarily be associated with braking. The frequency may also be influenced based on the input of other sensors, such as a sensor that detects the activation of the towing vehicle's brakes or suspension stabilization systems etc. Obtaining location readings at fixed intervals would achieve the desired goals when the towing vehicle was not actively braking. However, when approaching a known change in terrain or traffic, the time period between data points is altered in anticipation of a change in towing vehicle action. For example, when approaching a curve, intersection, or downhill grade, the frequency in which position readings are obtained, can and should be increased. Likewise, reacting to the sudden application of the towing vehicle's brakes due to an unexpected event, such as a deer crossing the road, would also make a GPS interaction frequency increase desirable. Such adjustment in sample frequency may be initiated manually by the driver of the towing vehicle, perhaps during operations in a construction zone, wooded areas, nature preserves, at night, etc., or automatically in response to certain criteria. Increasing sample frequency, either when going down hill or in anticipation of doing so, improves towed vehicle braking or braking of the towing vehicle. Another reason for varying sample frequency is related to the calculations performed with previous location readings. If these calculations indicate a change, such as reduction in speed without towing vehicle braking, an increase in sampling frequency could be desirable. Additional sensors, such as a throttle position sensor, may also be used to detect changes that predict a need to alter the sample frequency.

It is another aspect of embodiments of the present invention to employ a system that is not fully GPS based, i.e., a hybrid system. For example, a GPS unit may be incorporated into a traditional brake controller or the brake controller may be associated with a stand alone GPS unit to obtain GPS data. In one embodiment of the present invention, only altitude data obtained from the GPS device would be used for integration with traditional inertial readings such that hill accents, and their inherent gravitational affects, are identified and possibly ignored by the brake controller. GPS data could be used by an inertia based controller to predict changes in inertia, i.e., ascending or descending a hill, going around a curve, etc. In such a situation, gravitational and centrifugal effects would be ignored by the brake controller's processor. That is, the GPS vertical position is used in conjunction with a conventional inertia-sensing device and the vertical inertia data could be isolated through various mathematical manipulations.

In another embodiment of a hybrid system, acceleration from the inertia sensor and GPS based vehicle elevation data are fed into a microprocessor and a calculation of the inertia due to braking is more accurately determined. The combined data is used to apply the towed vehicle brakes. One of skill in the art will appreciate that both the vertical GPS and vertical inertia data may be collected for comparison by the microprocessor as well. However, using the GPS system to determine only the vertical position of the vehicle allows the inertia sensor to be used exclusively for monitoring the position in the vehicle's horizontal plane. Depending on whether single or dual axis accelerometers are used for horizontal detection, improved accuracy in inertia detection can thus be achieved. Further, unlike some current dual axis inertia sensors, this approach would not ignore changes in vertical position. That is, vertical changes can be used to adjust the towed braking or compared with GPS information to influence towed vehicle braking.

It is another aspect of the present invention to use the change in horizontal position sensed by the towing vehicle's speedometer to determine the approximate speed of the vehicle rather than exclusively using all GPS data to determine speed. This technique reduces the amount of calculations the microprocessor is required to perform, which will influence the speed and cost of the microprocessor. In addition, if the sensed horizontal speed indicates a braking situation, all GPS data may be polled to determine how much towed braking is desirable.

It is yet another aspect of the present invention to exclusively use horizontal GPS data, which is not as accurate as using three dimensional data, but would provide additional information for use by a controller of towed vehicle braking systems. For example, the horizontal information provides vehicle speed information which is not used by most current towed vehicle brake controller systems and ignores all vertical data to discount the influence of vertical forces, which most inertia-based brake controllers are unable to exclude. The system would operate similar to a three-dimensional system, however, the microprocessor would not be able to consider vertical events in determining the optimum amount of towed vehicle braking. Preferably, factors considered would be vehicle speed, change thereof, and sample frequency.

It is another aspect of the present invention to employ a microprocessor that collects data from both the GPS and the other sources such that all collected data can be properly weighed and evaluated. Examples of other data sources include brake lights, suspension stability systems, steering wheel position, antilock braking system activity, throttle position, inertial data, etc.

It is yet another aspect of the invention to provide a GPS based system for use with towed vehicles employing electric rather than hydraulic brakes. While electric vehicle brakes are not widely installed in vehicles, brake by wire and electric brakes, alone or combined with hydraulic braking systems, may conceivably be used in the future. It is contemplated that these systems, unlike the current hydraulic braking systems, will provide an electric signal to the towing vehicle brakes that will be proportional to the desired level of brake pedal position, though not necessarily linearly proportional. The monitoring of the electronic braking signal is one way to determine what level of towed vehicle braking should be applied. In one embodiment, the towing vehicle electric brake signal may be used as the primary input to the brake controller of the towed vehicle. However, it is likely that each wheel of the towing vehicle will generate different braking signals based on the primary input plus other factors, similar to conventional ABS hydraulic brake systems. So it is not certain that there will be a net, or average, electrical signal that will represent the necessary amount of towed vehicle braking. One possible approach to deal with this issue would be to use a mathematical combination of the braking applied signal at each electric brake of the towing vehicle which would be used to represent the desirable towing vehicle braking quotient. Another approach could be to use a common signal, which represents an average of the amount of force being applied to the towing vehicles braking system (similar to brake pedal position data), is obtained and used to dictate either the starting braking level or the most desired braking level for the towed vehicle.

It must be noted that in all the examples and embodiments described herein, the GPS system could be part of the towing or towed vehicle, part of the brake controller of the towing or towed vehicle, or an independent GPS unit associated with the brake controller of the towing or towed vehicle. Likewise, the brake controller could be independent or integrated into the towing or towed vehicle.

In addition to the foregoing, independent data from the GPS system and an inertia-based system may be compared to determine optimum brake application. One method uses GPS data to determine vehicle speed and an accelerometer to determine inertial changes. In this case, the application of the towed brakes is predominately based on the inertia change with vehicle speed information used to increase or decrease the severity of braking. Yet another method uses GPS obtained vertical change data to determine a factor that would be used to modify (i.e., compensate for gravitational influences) deceleration sensed by the inertia device. The identification and accounting allows for more accurate inertial braking determination.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention, as well as, in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and, together with the general description of the invention given above, and the detailed description of the drawings given below, serve to explain the principals of these inventions.

FIG. 1 is a flow chart showing one embodiment of the present invention;

FIG. 2 is a flow chart showing one embodiment of the present invention;

FIG. 3 is a flow chart showing one embodiment of the present invention;

FIG. 4 is a flow chart showing one embodiment of the present invention; and

FIG. 5 is a flow chart showing one embodiment of the present invention.

In certain instances, details that are not necessary for an understanding of the invention or that render aspects of the inventions difficult to perceive may have been omitted. It should be understood, of course, that the invention is not necessarily limited to the particular embodiments illustrated herein.

### DETAILED DESCRIPTION

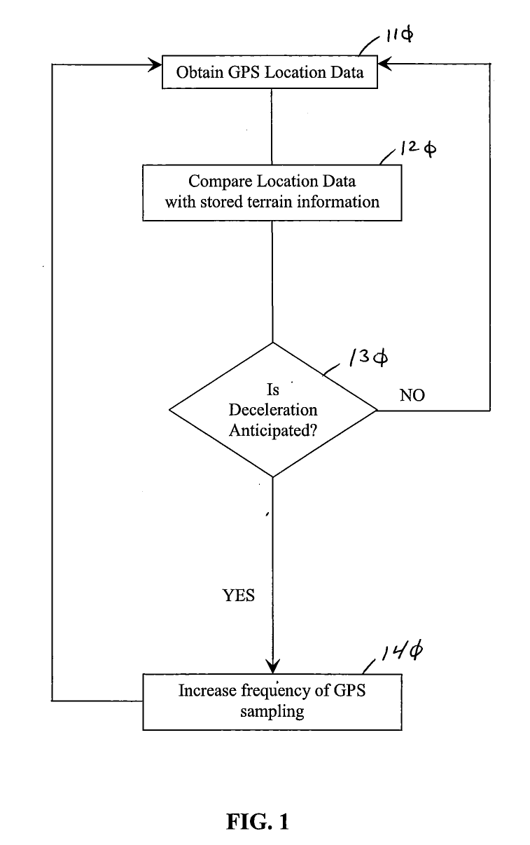

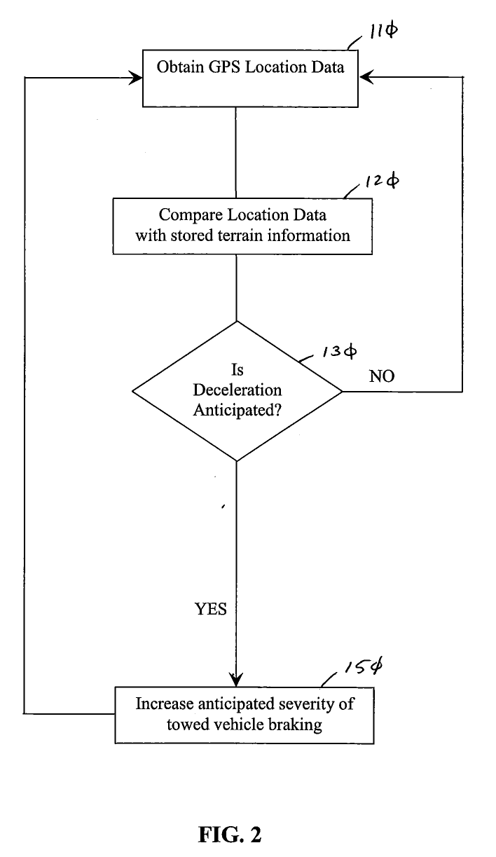

Referring now to FIGS. 1 and 2, one embodiment of the present invention that uses all three GPS dimensions exclusively is described. A brake controller obtains successive GPS data 110 to assess a location and motion of the towing or towed vehicles in each of the three GPS dimensions (two in the horizontal plane and one in the vertical plane) and feeds the collected data to a microprocessor. Based on the location data and terrain information, the microprocessor 120 determines the likely location-based condition of the vehicles and determines what braking action, if any, is needed or desirable 130 at the towed or towing vehicle. Common actions include changing GPS data sampling frequency 140, applying towed vehicle brakes, adjusting the currency or anticipated severity of towed vehicle braking 150, ceasing vehicle brake application, etc.

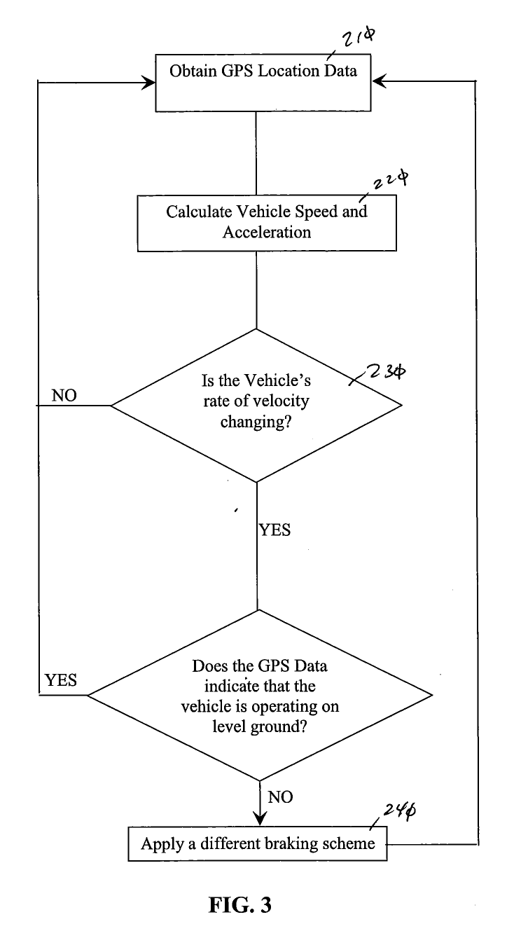

Referring now to FIG. 3, the GPS location information 210 of one embodiment of the invention is mathematically processed to determine vehicle speed 220 and the rate of change thereof. That is, speed reductions are used to determine the rate of towing vehicle deceleration and the microprocessor applies the towed brakes based upon a combination of factors discussed herein. Increasing speed is ignored when GPS-obtained location data indicates that the vehicle is operating on level ground. However, if sensed speed and altitude indicate a descent 230, i.e., indicating down grade, the controller will anticipate the need for more aggressive braking than that on a level surface 240. Therefore, the microprocessor determines that it is desirable to select a different towed vehicle braking algorithm should the towing vehicle begin to reduce its speed. Any decrease in towing vehicle speed, i.e. associated with going up a hill, are ignored or used to reduce the amount of anticipated braking force needed as compared to that needed for level ground operations. Gathered information may also be used to change sampling frequency in anticipation of a downhill event following an uphill event. For example, decreases in vehicle speed are ignored or used to increase the magnitude of braking in down hill situations versus level situations. The microprocessor then determines whether to apply the towed brakes based on formulas, tables other available thresholds, or other formula known in the field.

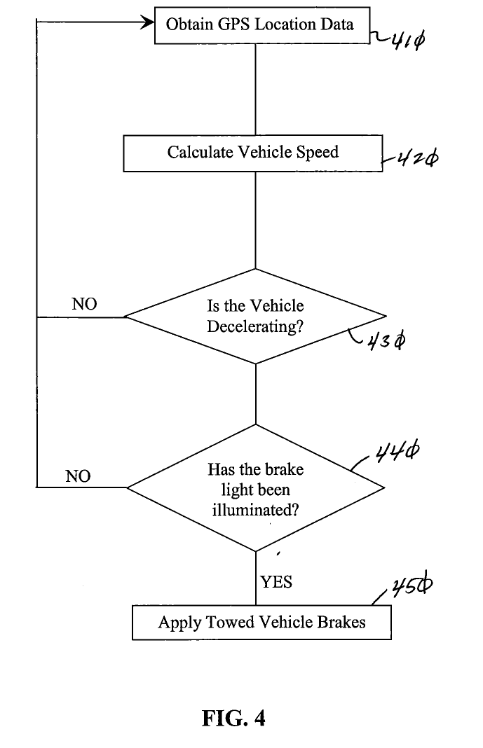

Referring now to FIG. 4, another embodiment of the present invention employs GPS positioning 410 used exclusively, or with any combination of numerous other vehicle sensors, such as a brake light detection sensor. The GPS based system provides information, such as towing vehicle speed 420 and acceleration 430, to a controller. Thus the GPS information is not limited to comparing the towing vehicle's location to terrain information as described above. The brake light and indicator signal 440 is also monitored to assess whether the towing vehicle driver has applied the vehicles brakes. If the towing vehicle is braking and the brake light is illuminated, then the towed vehicle s brakes are applied 450. In the case of a manual transmission vehicle, a system that was solely GPS based could apply the towed vehicle's brakes in response to deceleration created when the towing vehicle shifts into a lower gear, which may be undesirable. The combination of the brake light detection and the GPS information could limit towed vehicle braking to only cases when the towing vehicle brakes are actually in use.

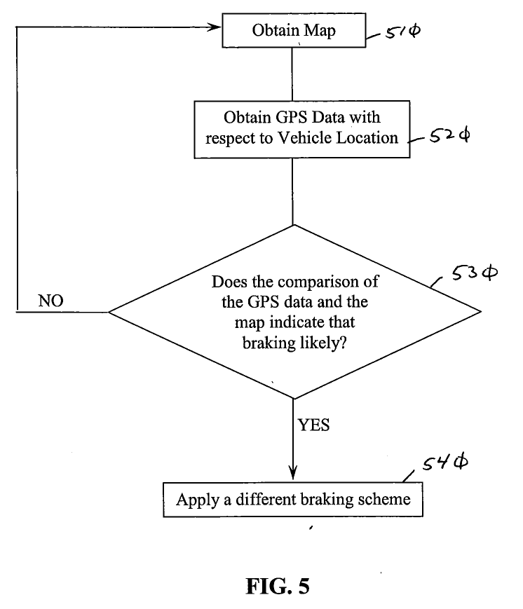

Referring now to FIG. 5, maps may be used in conjunction with the GPS-based braking control system. In one embodiment of the present invention, maps are stored 510 or downloaded (selectively or automatically) while the towing vehicle is in transit. In addition, multiple maps could be used, with one being for terrain and another being for traffic control. The maps are continually referenced or are wirelessly downloaded as demanded by the logic system of the brake controllers. In operation, if a stored traffic map 530 indicates the vehicle was approaching an intersection, the braking system could anticipate possible braking action 540. The addition of mapping (terrain, traffic control, or others) allows additional functionality. The uses of maps provides some level of braking anticipation wherein the brake controller may at least partially predict an upcoming braking situation in which the vehicle may be braking and modify the brake controller's operation to be better prepared if the anticipated event actually occurs. An example of this is when a map indicates a long down hill grade. The brake controller anticipates increases of speed due to the elevation change followed by moderate braking to reduce the speed of, but not to stop, the towed vehicle. Thus the towed braking can be better matched to the towing vehicle braking.

While various embodiments of the present invention have been described in detail, it is apparent that modifications and alterations of those embodiments will occur to those skilled in the art. It is to be expressly understood that such modifications and alterations are within the scope and spirit of the present invention, as set forth in the following claims.

What is claimed is:

1. A system for the activation of a brake mechanism of a towed vehicle, comprising:
a sensing device with an integrated logic device;
a power device associated with said sensing device;
a brake actuation device associated with said sensing device; and
wherein said sensing device employs a global positioning system (GPS) sensing device that senses the location of the auxiliary braking system.

2. The system of claim 1, wherein said logic device a microprocessor.

3. The system of claim 1, wherein said power device is a metal-oxide-semiconductor field-effect transistor.

4. The system of claim 1, wherein said integrated logic device uses GPS data solely to control towed vehicle brake actuation.

5. The system of claim 1, wherein said sensing device further includes an inertia sensing device.

6. The system of claim 5, wherein said integrated logic device uses GPS data to sense at least one of ascents, descents, and travel around a curve and information related thereto is used to condition data of the inertia sensing device to control towed vehicle brake actuation.

7. The system of claim 1, wherein said sensing device further includes a brake light sensor.

8. The system of claim 1, wherein said sensing device further includes an inertia sensing device and a brake light sensor.

9. The system of claim 8, wherein said integrated logic device uses GPS data to sense at least one of ascents, descents, and travel around a curve and information related thereto is used to condition data of said inertia sensing device to control brake actuation; and
wherein the brakes of said towed vehicle are only actuated if said brake light sensor indicates that the brakes of the towing vehicle have been actuated.

10. The system of claim 1, further including a remote device for positioning within the towing vehicle, the remote device having at least one indicator related to the performance of the auxiliary braking system and the remote device being capable of selectively altering the braking logic.

11. The system of claim 1, further comprising an emergency braking switch that activates the same when the towing vehicle is spaced a predetermined distance from the towed vehicle.

12. The system of claim 1, wherein the global positioning system periodically determines the location of the braking system.

13. A method of controlling an auxiliary braking system that uses a global positioning system (GPS) to assess the position thereof, comprising:
obtaining GPS location data;
using said GPS data to define a location of the auxiliary braking system on a stored map;
assessing said map to ascertain whether said location is approximate to at least one of a predetermined terrain or traffic situation; and
changing at least one operable characteristic of the auxiliary braking system.

14. The method of claim 13 wherein the at least one operable characteristic is a frequency in which GPS data is acquired.

15. The method of claim 13 wherein the at least one operable characteristic is a braking magnitude.

16. The method of claim 13, wherein said terrain situation is at least one of an ascent, descent and traveling around a curve.

17. The method of claim 13, wherein said GPS data is used to ascertain the change of elevation of the auxiliary braking system.

18. The method of claim 13, wherein said GPS data is used in conjunction with the stored map to ascertain the elevation of the auxiliary braking system.

19. The method of claim 13, further including changing the amount of braking force to be applied by the auxiliary braking system.

20. The method of claim 13, further comprising only facilitating braking a towed vehicle braking system.

21. The method of claim 13, wherein said traffic situation is related to the proximity of the auxiliary braking system to at least one of an urban area or a construction zone.

22. A method of controlling an auxiliary braking system positioned in a vehicle that uses a global positioning system (GPS) to assess the position thereof, comprising:
obtaining successive GPS location data;
calculating vehicle speed and acceleration of the vehicle;
using said GPS data to define a location of the auxiliary braking system on a stored map;
assessing said map to ascertain whether said location is approximate to at least one of a terrain or traffic situation; and
changing the potentially applied amount of towed vehicle braking according to the approximate terrain or traffic situation.
